(19) United States
(12) Patent Application Publication
(10) Pub. No.: US 2026/0149343 A1
(43) Pub. Date: May 28, 2026

(54) Active Motor Warning Method and Active Motor Warning System Capable of Detecting Various Messages

(71) Applicant: WELTREND SEMICONDUCTOR INC., Hsinchu (TW)

(72) Inventors: Te-Wei Hsu, Hsinchu (TW); Ta Hsien, Hsinchu (TW); Hung-Ming Chang, Hsinchu (TW); Chien-Tsung Hung, Hsinchu (TW); Meng-Che Tsai, Hsinchu (TW)

(73) Assignee: WELTREND SEMICONDUCTOR INC., Hsinchu (TW)

(21) Appl. No.: 19/035,892

(22) Filed: Jan. 24, 2025

(30) Foreign Application Priority Data
Nov. 28, 2024 (TW) 113146018

(51) Int. Cl. H02K 11/35

(52) U.S. Cl. CPC H02K 11/35

(57) ABSTRACT

An active motor warning method includes using a motor drive module to drive a motor, using ambient environment sensors to detect at least one environmental state and transmitting the at least one environmental state to the motor drive module, generating a pulse-width modulation signal including a first message and a second message by the motor drive module, and actively transmitting the pulse-width modulation signal to a host through a frequency generator output pin. The first message of the pulse-width modulation signal includes a rotational speed of the motor. The second message of the pulse-width modulation signal includes at least one operating state of the motor and/or the at least one environmental state.

### BACKGROUND OF THE INVENTION

### 1. Field of the Invention

The present invention relates to an active motor warning method and an active motor warning system, and more particularly, an active motor warning method and an active motor warning system capable of transmitting a plurality of messages based on a duty cycle and a frequency of a pulse-width modulation signal.

### 2. Description of the Prior Art

Conventional motor control system typically uses a frequency generator (FG) output pin to relay motor rotational speed, so that a host can monitor an operating state of the motor in real time.

However, in the conventional motor control system, there are obvious limitations, as described below. The FG pin can only transmit the rotational speed of the motor. It cannot transmit other key information. For example, an operating state (e.g., a current state and a stability state) of the motor and an environmental state (e.g., a leakage state and a temperature state) cannot be transmitted through the FG output pin. In order to transmit such additional information to the host, a conventional solution is to introduce a communication interface, such as Inter-Integrated Circuit (I2C). However, since the communication interface requires additional lines (cables) in between, the complexity, the number of pins, and the cost of the system are significantly increased.

### SUMMARY OF THE INVENTION

In an embodiment, an active motor warning method is disclosed. The active motor warning method comprises using a motor drive module to drive a motor, using an ambient environment sensor to detect at least one environmental state and transmitting the at least one environmental state to the motor drive module, generating a pulse-width modulation signal comprising a first message and a second message by the motor drive module, and actively transmitting the pulse-width modulation signal to a host through a frequency generator output pin. The first message of the pulse-width modulation signal comprises a rotational speed of the motor. The second message of the pulse-width modulation signal comprises at least one operating state of the motor and/or the at least one environmental state.

In another embodiment, an active motor warning system is disclosed. The active motor warning system comprises a motor, an ambient environment sensor, a motor drive module coupled to the motor and the ambient environment sensor and configured to drive the motor, and a host coupled to the motor drive module. The active motor warning system is capable of performing the active motor warning method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an active motor warning system according to an embodiment of the present invention.

FIG. 2 is a schematic diagram of setting a frequency of a pulse-width modulation signal of the active motor warning system in FIG. 1.

FIG. 3 is a schematic diagram of the pulse-width modulation signal having a duty cycle of 75% of the active motor warning system in FIG. 1.

FIG. 4 is a schematic diagram of the pulse-width modulation signal having the duty cycle of 25% of the active motor warning system in FIG. 1.

FIG. 5 is a flowchart of performing an active motor warning method by the active motor warning system in FIG. 1.

### DETAILED DESCRIPTION

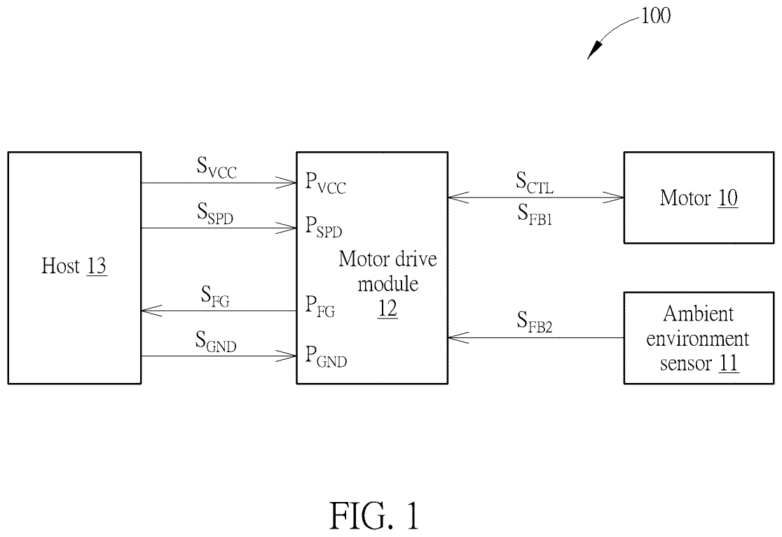

FIG. 1 is a block diagram of an active motor warning system 100 according to an embodiment of the present invention. The active motor warning system 100 includes a motor 10, an ambient environment sensor 11, a motor drive module 12, and a host 13. The motor 10 can be a brushless direct current (DC) motor or any reasonable type of motor. The ambient environment sensor 11 may include a liquid leakage sensor, an ambient temperature sensor, a vibration sensor, a sound sensor, and/or a humidity sensor. The ambient environment sensor 11 can be disposed outside the motor drive module 12 and is used for sensing environmental physical characteristics in the vicinity of the motor drive module 12. The motor drive module 12 is coupled to the motor 10 and the ambient environment sensor 11 and is used for driving the motor 10. The motor drive module 12 may be a four-wire motor drive module. The host 13 is coupled to the motor drive module 12. The host 13 may be a personal computer, an upper (or master) computer, or a workstation. The host 13 can adjust the current operation mode of the motor 10 based on a state reported by the motor drive module 12. In the active motor warning system 100, the ambient environment sensor 11 can detect at least one environmental state. The ambient environment sensor 11 transmits at least one environmental state to the motor drive module 12. The motor drive module 12 generates a motor rotational speed signal S_{FG} having a pulse-width modulation (PWM) waveform including a first message and a second message. The motor drive module 12 actively transmits the motor rotational speed signal S_{FG} to the host 13 through a frequency generator (FG) output pin P_{FG}. The first message of the motor rotational speed signal S_{FG} includes the rotational speed of the motor 10. The second message of the motor rotational speed signal S_{FG} includes at least one operating state of the motor 10 and/or the at least one environmental state. Details of the operations of the active motor warning system 100 are illustrated below.

In FIG. 1, the motor drive module 12 includes a driving voltage pin P_{VCC}, a rotational speed control pin P_{SPD}, a frequency generator output pin P_{FG}, and a ground pin P_{GND}. The driving voltage pin P_{VCC} is used for receiving a driving voltage S_{VCC} provided by the host 13. The rotational speed control pin P_{SPD} is used for receiving the rotational speed control signal S_{SPD} provided by the host 13. The ground pin P_{GND} is used for receiving a ground voltage S_{GND} provided by the host 13. The frequency generator output pin P_{FG} can be used for transmitting the motor rotational speed signal S_{FG}, which carries the rotational speed, at least one operating state, and/or at least one environmental state, from the motor drive module 12 to the host 13. In this embodiment, the waveform of the motor rotational speed signal S_{FG} can be the PWM signal waveform. Therefore, for convenience of description, the motor rotational speed signal S_{FG} is referred to as the pulse-width modulation signal S_{FG} hereinafter. As mentioned previously, the motor drive module 12 can drive the motor 10. For example, the motor drive module 12 can generate a drive control signal S_{CTL} to drive the motor 10. The drive control signal S_{CTL} can be a three-phase U/V/W signal. The motor 10 can also report the operating state to the motor drive module 12. For example, the motor 10 can transmit the rotational speed, the voltage state, and/or the overcurrent detection state to the motor drive module 12 through a first feedback signal S_{FB1}. The ambient environment sensor 11 can detect at least one environmental state, and transmit at least one environmental state to the motor drive module 12 through a second feedback signal S_{FB2}. In the embodiment, the environmental state can include a liquid leakage state, an ambient temperature state, a vibration state, a sound state, and/or a humidity state.

In the motor warning system 100, the motor drive module 12 can adjust the PWM signal S_{FG} after receiving information on at least one operating state and/or at least one environmental state based on the first feedback signal S_{FB1} and the second feedback signal S_{FB2}. Therefore, the frequency of the PWM signal S_{FG} output by the motor drive module 12 corresponds to the first message (such as the rotational speed). The duty cycle of the PWM signal S_{FG} output by the motor drive module 12 corresponds to the second message (such as at least one operating state and/or the at least one environmental state). Therefore, the host 13 can analyze the frequency and duty cycle of the PWM signal S_{FG} by receiving the PWM signal S_{FG} output from the frequency generator output pin P_{FG} of the motor drive module 12. Then, the host 13 can acquire the first message and the second message based on the frequency and duty cycle of the PWM signal S_{FG}. Since the first message and the second message carry information on the rotational speed, the at least one operating state, and/or the at least one environmental state, the host 13 can adjust the rotational speed of the motor 10 based on the first message and the second message through the rotational speed control signal S_{SPD}. Alternatively, the host 13 can determine whether the at least one operating state and/or the at least one environmental state of the motor 10 is abnormal based on the PWM signal S_{FG}. If the at least one operating state and/or the at least one environmental state of the motor 10 is abnormal, the host 13 can generate a warning signal. For example, when the ambient temperature of the motor 10 is too high or the voltage state is abnormal, the host 13 can generate the warning signal and reduce the rotational speed of the motor 10 through the rotational speed control signal S_{SPD}, or stop the operation of the motor 10. Any reasonable technical or hardware modification falls into the scope of the embodiments.

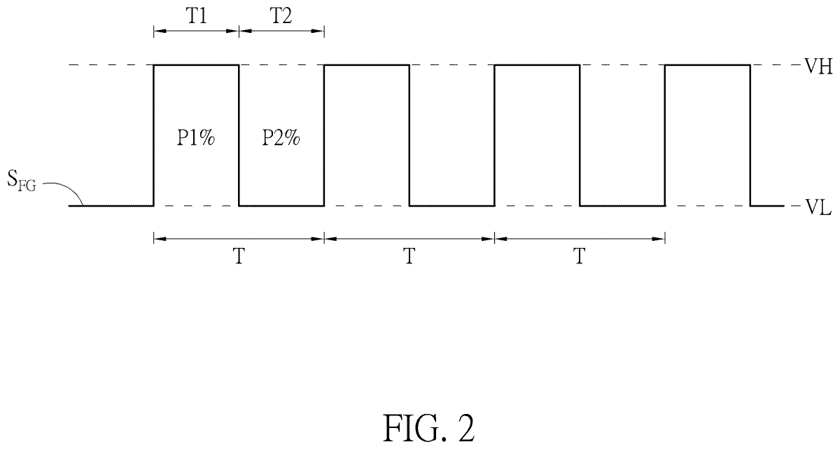

FIG. 2 is a schematic diagram of setting the frequency of the PWM signal S_{FG} of the active motor warning system 100. As mentioned previously, the frequency of the PWM signal S_{FG} corresponds to the first message (such as the rotational speed). The frequency of the PWM signal S_{FG} and the rotational speed of the motor 10 can be adjusted based on a mapping table. For example, the frequency of the PWM signal S_{FG} is between 0 and 1000 hertz (Hz), corresponding to the rotational speed of the motor 10 of 0 to 30,000 revolutions per minute (rpm). In FIG. 2, the PWM signal S_{FG} is formed by a plurality of square waves. The PWM signal S_{FG} periodically alternates between a high voltage VH and a low voltage VL. Within a period T, the time length of the PWM signal S_{FG} at the high voltage VH is T1. The time length of the PWM signal S_{FG} at the low voltage VL is T2. Therefore, the period T is a total time length of the time length T1 at the high voltage VH and the time length T2 at the low voltage VL (i.e., T=T1+T2). Moreover, a ratio of the time length T1 at the high voltage VH to the period T can be defined as the duty cycle of the PWM signal S_{FG}. In FIG. 2, the duty cycle of the PWM signal S_{FG} is P1%, equal to T1/T. Therefore, a blanking ratio can be defined as P2%=T2/T, and P1%+P2%=100%. In the active motor warning system 100, the first message corresponds to the frequency of the PWM signal S_{FG}, which can be adjusted based on the rotational speed of the motor 10. For example, when the rotational speed of the motor 10 increases, the period T can be gradually decreased so as to increase the frequency of the PWM signal SFG (i.e., frequency=1/T). When the rotational speed of the motor 10 decreases, the period T can be increased so as to decrease the frequency of the PWM signal S_{FG}.

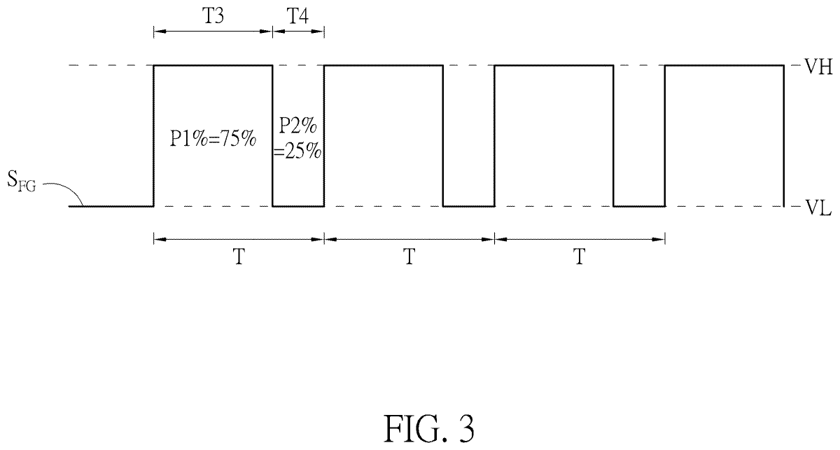

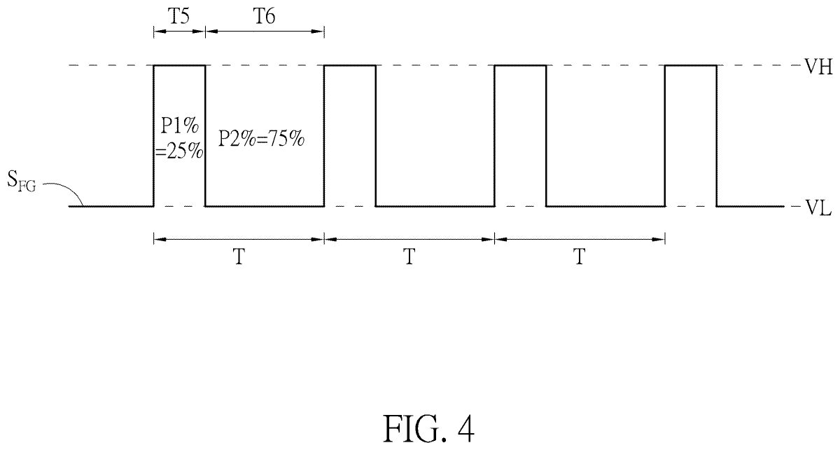

FIG. 3 is a schematic diagram of the PWM signal S_{FG} having a duty cycle of 75% of the active motor warning system 100. FIG. 4 is a schematic diagram of the PWM signal S_{FG} having a duty cycle of 25% of the active motor warning system 100. As mentioned previously, the duty cycle of the PWM signal S_{FG} corresponds to the second message (e.g., at least one operating state and/or at least one environmental state). The duty cycle of the PWM signal S_{FG} can be adjusted based on information about the at least one operating state of the motor 10 and/or at least one environmental state by using the mapping table. Details of the mapping table are illustrated below. As shown in FIG. 2 to FIG. 4, the frequency and the duty cycle of the PWM signal S_{FG} can be adjusted simultaneously based on the period T and the time lengths T1 to T6. Therefore, the PWM signal S_{FG} can be regarded as a two-dimensional data signal carrying the first message (e.g., rotational speed) and the second message (e.g., the at least one operating state and/or at least one environmental state) simultaneously. For the active motor warning system 100, it is not necessary to use additional lines (cables) or communication interfaces to detect various states of the motor 10 and to achieve the desired warning effect.

In the active motor warning system 100, the above-mentioned “mapping table” includes two portions. The first portion corresponds to mapping relationships between rotational speeds of the motor 10 and frequencies of the PWM signal S_{FG}. The second portion corresponds to mapping relationships between operating states and duty cycles of the PWM signal S_{FG}. In an embodiment, the mapping table is shown in Table 1.

TABLE 1

| | frequencies (Hz) of | rotational speeds (rpm) |
|---|---|---|
| | the PWM signal S_{FG} | of the motor 10 |
| First | 0 | 0 |
| message | . | . |
| | . | . |
| | . | . |
| | 1000 | 30000 |

| | duty cycles (P1%) of | Liquid leakage |
|---|---|---|
| | the PWM signal S_{FG} | Detection |
| Second | 10% ≤ P1% < 60% | Normal state |
| message | 80% ≤ P1% < 90% | Abnormal state |

In the embodiment, if the environmental state (liquid leakage detection state) is in a first state (normal state), the duty cycle P1% of the PWM signal S_{FG} is within a first range (10%≤P1%<60%). If the environmental state (liquid leakage detection state) is in a second state (abnormal state), the duty cycle P1% of the PWM signal S_{FG} is within a second range (80%≤P1%<90%). The first range and the second range are non-overlapped. Therefore, after the motor drive module 12 outputs the PWM signal S_{FG} to the host 13 through the frequency generator output pin P_{FG}, the host 13 can analyze the PWM signal SFG to determine the rotational speed and liquid leakage detection state of the motor 10. In another embodiment, the mapping table can be shown in Table 2.

TABLE 2

| | frequencies (Hz) of | rotational speeds (rpm) |
|---|---|---|
| | the PWM signal S_{FG} | of the motor 10 |
| First | 0 | 0 |
| message | . | . |
| | . | . |
| | . | . |
| | 1000 | 30000 |

| | | | | Ambient |
|---|---|---|---|---|
| | duty cycles (P1%) of | Liquid leakage | Overcurrent | temperature |
| | the PWM signal S_{FG} | Detection | detection | detection |
| Second | 10% ≤ P1% < 12% | Normal state | Overcurrent | High temperature |
| message | 12% ≤ P1% < 14% | Normal state | Overcurrent | Normal |
| | | | | temperature |
| | 14% ≤ P1% < 16% | Normal state | Overcurrent | Low temperature |
| | 16% ≤ P1% < 18% | Normal state | Normal current | High temperature |
| | 18% ≤ P1% < 20% | Normal state | Normal current | Normal |
| | | | | temperature |
| | 20% ≤ P1% < 22% | Normal state | Normal current | Low temperature |
| | 22% ≤ P1% < 24% | Abnormal state | Overcurrent | High temperature |
| | 24% ≤ P1% < 26% | Abnormal state | Overcurrent | Normal |
| | | | | temperature |
| | 26% ≤ P1% < 28% | Abnormal state | Overcurrent | Low temperature |
| | 28% ≤ P1% < 30% | Abnormal state | Normal current | High temperature |
| | 30% ≤ P1% < 32% | Abnormal state | Normal current | Normal |
| | | | | temperature |
| | 32% ≤ P1% | Abnormal state | Normal current | Low temperature |

In Table 2, the duty cycle of the PWM signal S_{FG} is set to be within one of a plurality of ranges. Each of the plurality of ranges corresponds to a combination of a plurality of environmental states and/or at least one operating state. The plurality of ranges are non-overlapped. For example, when the duty cycle of the PWM signal S_{FG} is within the range of 100%≤P1%<12%, no liquid leakage is detected, the overcurrent is detected, and the ambient temperature is high. When the duty cycle of the PWM signal S_{FG} is within the range of 120%≤P1%<14%, no liquid leakage is detected, the overcurrent is detected, and the ambient temperature is normal. Therefore, after the motor drive module 12 outputs the PWM signal S_{FG} to the host 13 through the frequency generator output pin P_{FG}, the host 13 can analyze the PWM signal S_{FG} to determine the rotational speed of the motor 10 and obtain real-time reports of various states. In other words, in the active motor warning system 100, the pulse-width modulation signal S_{FG} can carry information on the plurality of states and the rotational speed of the motor 10.

However, it should be understood that Table 2 is merely an embodiment and is not intended to limit the scope of the embodiment. For example, the plurality of ranges of the duty cycle of the PWM signal S_{FG} can be changed to a plurality of values. In an embodiment, the duty cycle of the PWM signal S_{FG} may be any one value of {10%, 12%, 14%, 16%, 18%, 20%, 22%, 24%, 26%, 28%, 30%, 32%}. Each of the plurality of values corresponds to a combination of the liquid leakage detection state, the overcurrent detection state, and the ambient temperature detection state, as shown in Table 3.

TABLE 3

| | frequencies (Hz) of | rotational speeds (rpm) |
|---|---|---|
| | the PWM signal S_{FG} | of the motor 10 |
| First | 0 | 0 |
| message | . | . |
| | . | . |
| | . | . |
| | 1000 | 30000 |

| | duty cycles (P1%) of | Liquid leakage | Overcurrent | Ambient temperature |
|---|---|---|---|---|
| | the PWM signal S_{FG} | Detection | detection | detection |
| Second | 10% | Normal state | Overcurrent | High temperature |
| message | 12% | Normal state | Overcurrent | Normal temperature |
| | 14% | Normal state | Overcurrent | Low temperature |
| | 16% | Normal state | Normal current | High temperature |
| | 18% | Normal state | Normal current | Normal temperature |
| | 20% | Normal state | Normal current | Low temperature |
| | 22% | Abnormal state | Overcurrent | High temperature |
| | 24% | Abnormal state | Overcurrent | Normal temperature |
| | 26% | Abnormal state | Overcurrent | Low temperature |
| | 28% | Abnormal state | Normal current | High temperature |
| | 30% | Abnormal state | Normal current | Normal temperature |
| | 32% | Abnormal state | Normal current | Low temperature |

The construction of Table 3 is similar to that of Table 2. Thus, details are omitted here.

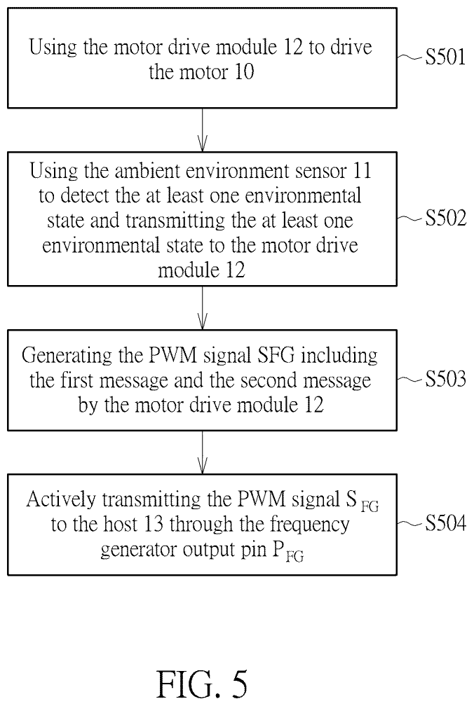

FIG. 5 is a flowchart of performing an active motor warning method by the active motor warning system 100. The active motor warning method includes step S501 to step S504. Any reasonable technical or hardware modification falls into the scope of the embodiment. Step S501 to step S504 are illustrated below.
Step S501: using the motor drive module 12 to drive the motor 10;
Step S502: using the ambient environment sensor 11 to detect the at least one environmental state and transmitting the at least one environmental state to the motor drive module 12;
Step S503: generating the PWM signal S_{FG} including the first message and the second message by the motor drive module 12;
Step S504: actively transmitting the PWM signal S_{FG} to the host 13 through the frequency generator output pin P_{FG}.

Details of steps S501 to S504 are previously illustrated. Thus, they are omitted here. In the active motor warning system 100, the PWM signal S_{FG} includes the first message and the second message. The first message includes the rotational speed of the motor 10, which is presented by the frequency of the PWM signal S_{FG}. The second message includes the at least one operating state of the motor 10 and/or at least one environmental state, which is presented by the duty cycle of the PWM signal S_{FG}. Therefore, the active motor warning system 100 does not need to introduce additional cables or communication interfaces to detect various states and can achieve the desired warning effect.

In summary, the present embodiments disclose an active motor warning method and an active motor warning system. The active motor warning system uses the frequency generator output pin to simultaneously transmit the rotational speed of the motor and a plurality of operating states and environmental information on the motor through the PWM signal without increasing additional cables or communication interfaces. Compared with the conventional motor control system, the active motor warning system of the embodiments can use the frequency and duty cycle of the PWM signal to transmit the rotational speed of the motor and other environmental state information. Therefore, the host can directly acquire comprehensive information from the frequency generator output pin to achieve real-time and effective monitoring and warning functions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An active motor warning method comprising:
using a motor drive module to drive a motor;
using an ambient environment sensor to detect at least one environmental state and transmitting the at least one environmental state to the motor drive module;
generating a pulse-width modulation signal comprising a first message and a second message modulated by the motor drive module; and
actively transmitting the pulse-width modulation signal to a host through a frequency generator output pin;
wherein the first message of the pulse-width modulation signal comprises a rotational speed of the motor, and the second message of the pulse-width modulation signal comprises at least one operating state of the motor and/or the at least one environmental state.

2. The method of claim 1, wherein generating the pulse-width modulation signal comprising the first message and the second message by the motor drive module comprises:
acquiring a look-up-table or a conversion formula;
modulating the pulse-width modulation signal by the motor drive module based on the look-up-table or the conversion formula such that a frequency of the pulse-width modulation signal corresponds to the first message; and
modulating the pulse-width modulation signal by the motor drive module based on the look-up-table or the conversion formula such that a duty cycle of the pulse-width modulation signal corresponds to the second message.

3. The method of claim 1, wherein the at least one environmental state comprises at least one member of a group comprising a leakage state, an ambient temperature state, a vibration state, a sound state, and a humidity state.

4. The method of claim 1, wherein the second message corresponds to a duty cycle of the pulse-width modulation signal, the duty cycle of the pulse-width modulation signal is within a first range when an environment state is in a first state, the duty cycle of the pulse-width modulation signal is within a second range when the environment state is in a second state, and the first range and the second range are non-overlapped.

5. The method of claim 1, wherein the second message corresponds to a duty cycle of the pulse-width modulation signal, the duty cycle of the pulse-width modulation signal is set within one of a plurality of ranges, each of the plurality of ranges corresponding to a combination of a plurality of environmental states and/or the at least one operating state, and the plurality of ranges are non-overlapped.

6. An active motor warning system comprising:
a motor;
an ambient environment sensor;
a motor drive module coupled to the motor and the ambient environment sensor and configured to drive the motor; and
a host coupled to the motor drive module;
wherein the ambient environment sensor detects at least one environmental state and transmits the at least one environmental state to the motor drive module, the motor drive module generates a pulse-width modulation signal including a first message and a second message, the motor drive module actively transmits the pulse-width modulation signal to the host through a frequency generator output pin, the first message of the pulse-width modulation signal comprises a rotational speed of the motor, and the second message of the pulse-width modulation signal comprises at least one operating state of the motor and/or the at least one environmental state.

7. The system of claim 6, wherein the motor drive module modulates the pulse-width modulation signal based on a look-up-table or a conversion formula previously configured such that a frequency of the pulse-width modulation signal corresponds to the first message, and the motor drive module modulates the pulse-width modulation signal by the motor drive module based on the look-up-table or the conversion formula such that a duty cycle of the pulse-width modulation signal corresponds to the second message.

8. The system of claim 6, wherein the at least one environmental state comprises at least one member of a group comprising a leakage state, an ambient temperature state, a vibration state, a sound state, and a humidity state.

9. The system of claim 6, wherein the second message corresponds to a duty cycle of the pulse-width modulation signal, the duty cycle of the pulse-width modulation signal is within a first range when an environment state is in a first state, the duty cycle of the pulse-width modulation signal is within a second range when the environment state is in a second state, and the first range and the second range are non-overlapped.

10. The system of claim 6, wherein the second message corresponds to a duty cycle of the pulse-width modulation signal, the duty cycle of the pulse-width modulation signal is set within one of a plurality of ranges, each of the plurality of ranges corresponding to a combination of a plurality of environmental states and/or the at least one operating state, and the plurality of ranges are non-overlapped.
